(19) United States
(12) Patent Application Publication
(10) Pub. No.: US 2024/0346325 A1
(43) Pub. Date: Oct. 17, 2024

(54) DYNAMIC DATABASE PARTITIONING USING ARTIFICIAL INTELLIGENCE TECHNIQUES

(71) Applicant: Dell Products L.P., Round Rock, TX (US)

(72) Inventors: Barun Pandey, Bangalore (IN); Saumyadipta Samantaray, Bangalore (IN); Dipsikha Rabha, Bangalore (IN)

(21) Appl. No.: 18/135,308

(22) Filed: Apr. 17, 2023

(51) Int. Cl. G06N 3/092

(52) U.S. Cl. CPC G06N 3/092

(57) ABSTRACT

Methods, apparatus, and processor-readable storage media for dynamic database partitioning using artificial intelligence techniques are provided herein. An example computer-implemented method includes identifying one or more performance issues associated with at least one database by processing activity data related to the at least one database; determining one or more partitioning actions to be carried out in connection with the at least one database by processing at least a portion of the activity data related to the one or more identified performance issues using one or more artificial intelligence techniques; and performing one or more automated actions based at least in part on the one or more determined partitioning actions.

### FIELD

The field relates generally to information processing systems, and more particularly to techniques for storage in such systems.

### BACKGROUND

Enterprises commonly use multiple databases to support various operations, and such multi-database usage often requires actions to maintain database-related performance. However, conventional database management approaches include reactive static techniques which can lead to costly over-allocation of storage space and/or related system downtime.

### SUMMARY

Illustrative embodiments of the disclosure provide dynamic database partitioning using artificial intelligence techniques.

An exemplary computer-implemented method includes identifying one or more performance issues associated with at least one database by processing activity data related to the at least one database, and determining one or more partitioning actions to be carried out in connection with the at least one database by processing at least a portion of the activity data related to the one or more identified performance issues using one or more artificial intelligence techniques. Also, the method includes performing one or more automated actions based at least in part on the one or more determined partitioning actions.

Illustrative embodiments can provide significant advantages relative to conventional database management approaches. For example, problems associated with costly over-allocation of storage space and/or related system downtime are overcome in one or more embodiments through automatically generating and/or implementing dynamic database partitioning recommendations using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for dynamic database partitioning using artificial intelligence techniques in an illustrative embodiment.

FIG. 2 shows example system architecture in an illustrative embodiment.

FIG. 3 shows an example workflow for training a partitioning recommendation model in an illustrative embodiment.

FIG. 4 shows an example deep learning neural network model used in an illustrative embodiment.

FIG. 5 is a flow diagram of a process for dynamic database partitioning using artificial intelligence techniques in an illustrative embodiment.

FIGS. 6 and 7 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

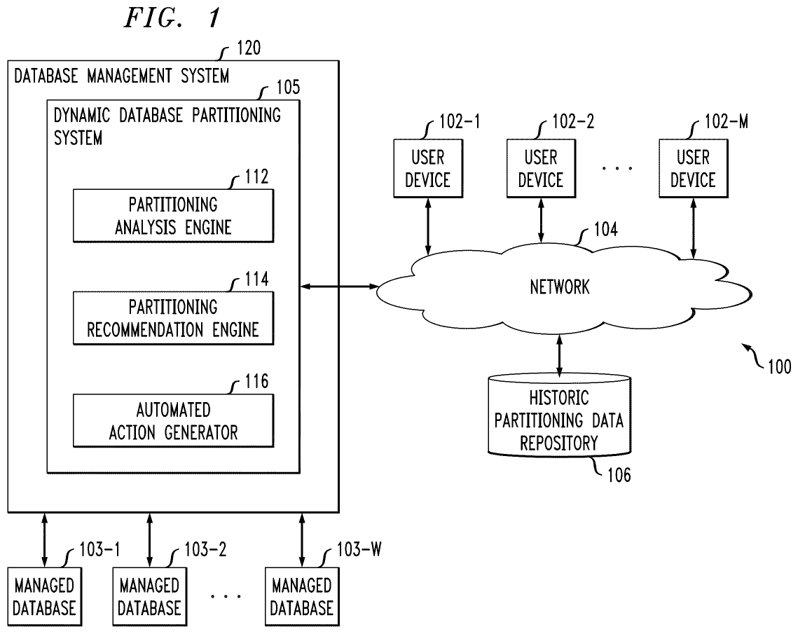

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is database management system 120, which includes dynamic database partitioning system 105. Also, as depicted in FIG. 1, database management system 120 is associated with and/or connected to managed databases 103-1, 103-2, . . . 103-W, collectively referred to herein as managed databases 103.

The user devices 102 may comprise, for example, mobile telephones, laptop computers, tablet computers, desktop computers or other types of computing devices. Such devices are examples of what are more generally referred to herein as “processing devices,” and may contain and/or be associated with one or more databases. Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, dynamic database partitioning system 105 can have an associated historic partitioning data repository 106 configured to store data pertaining to historical partition-related data and performance-related data associated with one or more databases.

The historic partitioning data repository 106 and the managed databases 103 in the present embodiment can be implemented using one or more storage systems associated with dynamic database partitioning system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with dynamic database partitioning system 105 are one or more input-output devices, which illustratively comprise keyboards, displays or other types of input-output devices in any combination. Such input-output devices can be used, for example, to support one or more user interfaces to dynamic database partitioning system 105, as well as to support communication between dynamic database partitioning system 105 and other related systems and devices not explicitly shown.

Additionally, dynamic database partitioning system 105 in the FIG. 1 embodiment is assumed to be implemented using at least one processing device. Each such processing device generally comprises at least one processor and an associated memory, and implements one or more functional modules for controlling certain features of dynamic database partitioning system 105.

More particularly, dynamic database partitioning system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows dynamic database partitioning system 105 to communicate over the network 104 with the user devices 102, and illustratively comprises one or more conventional transceivers.

The dynamic database partitioning system 105 further comprises partitioning analysis engine 112, partitioning recommendation engine 114, and automated action generator 116.

It is to be appreciated that this particular arrangement of elements 112, 114 and 116 illustrated in the dynamic database partitioning system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for dynamic database partitioning using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of database management system 120, managed databases 103, dynamic database partitioning system 105, and historic partitioning data repository 106 can be on and/or part of the same processing platform.

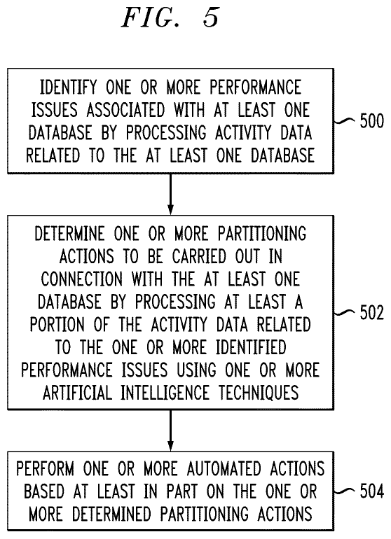

An exemplary process utilizing elements 112, 114 and 116 of an example dynamic database partitioning system 105 in computer network 100 will be described in more detail with reference to the flow diagram of FIG. 5.

Accordingly, at least one embodiment includes dynamic database partitioning using artificial intelligence techniques. As further detailed herein, such an embodiment includes implementing dynamic partitioning and indexing techniques that leverage historical data and one or more deep learning models. One or more embodiments can also include predicting and prescribing one or more storage performance tuning parameters (e.g., volumetric trend information, workload information, frequently executed queries, input-output query cost and lineage details (e.g., CPU cycles and input-output read-write information), existing partition information, data replication and archival strategy, performance attribute queries, etc.) based at least in part on context-related data for one or more given situations. By way of example, such an embodiment includes processing historical data using one or more machine learning algorithms to recommend one or more context-specific performance tuning configurations, for example, related to database partitioning and indexing. Such an embodiment can also include selecting at least one appropriate template for a particular storage-related context (e.g., as further detailed herein).

One or more embodiments include generating and/or implementing at least one deep reinforcement learning-based agent in connection with suggesting and/or recommending one or more database partitioning and/or indexing actions. Such a deep reinforcement learning-based agent learns and/or determines one or more decisions based at least in part on simulating and/or attempting different partitioning actions and monitoring the rewards (e.g., the runtime benefits) related thereto for a variety of different workloads. In one or more embodiments, such runtime benefits can include improved runtime performance on parameters such as volumetric trend information, workload information, frequently executed queries, input-output query cost and lineage details (e.g., CPU cycles and input-output read-write information), existing partition information, data replication and archival strategy, performance attribute queries, etc. Accordingly, at least one embodiment includes dynamically recommending at least one partitioning strategy for a given deployment and/or workload by leveraging historical data such as, for example, input from database log files, frequent query execution patterns, query costs and plan outputs, trend of volumetric growth, database health parameters during high volume transactions, etc.

Additionally, at least one embodiment includes performing one or more data engineering steps on historical data to facilitate extracting one or more important features and/or independent variables (e.g., database objects, data volumes, frequently queried columns, etc.) therefrom. Such extracted features and/or independent variables can be filtered out of the processed historical data to create one or more datasets that can be stored in at least one historical data repository for future model training and/or analysis.

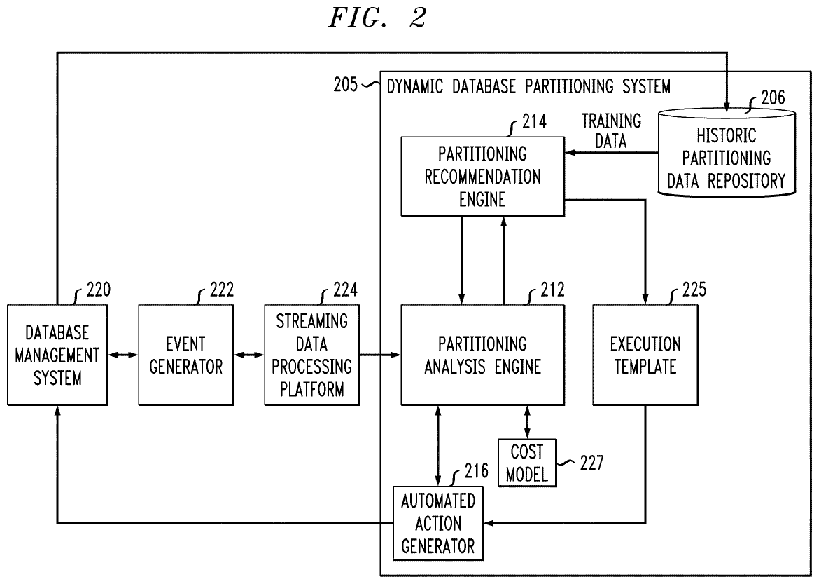

FIG. 2 shows example system architecture in an illustrative embodiment. In FIG. 2, performance-related events are generated by event generator 222 in connection with database management system 220 monitoring activity. For example, sales or order management systems' databases can be monitored by database management system 220 at various stages of a larger transaction process, and based at least in part thereon, event generator 222 can generate performance-related events for communicating the performance of one or more of the databases in question. Such events, generated by event generator 222, can then be passed, via streaming data processing platform 224, to dynamic database partitioning system 205 for processing by partitioning analysis engine 212.

By way of example, and in accordance with one or more embodiments, if partitioning analysis engine 212 identifies a performance issue with a given database, related event data are provided to and/or communicated to partitioning recommendation engine 214 (which is trained using data from historic partitioning data repository 206), which processes at least a portion of the event data to recommend at least one partition type and corresponding execution template 225. In one or more embodiments, database performance issues can be determined and/or identified by partitioning analysis engine 212 by analyzing input data against one or more threshold values of parameters such as, for example, volumetric trend information, workload information, frequently executed queries, input-output query cost and lineage details (e.g., CPU cycles and input-output read-write information), existing partition information, data replication and archival strategy, performance attribute queries, etc.

Also, in one or more embodiments, execution template 225 can follow a recommended query and/or data manipulation language (DML) statement syntax (based, for example, on the model recommendation), tailored to the type of database and including one or more pre-validation and post-validation checklists, as well as the scheduled time of execution. Accordingly, referring again to FIG. 2, the execution template 225 is then provided to automated action generator 216, which can automatically initiate one or more automated actions such as, for example, outputting the execution template 225 to one or more separate systems (such as database management system 220) for further action, and/or dynamically performing the at least one partition in connection with the given database in question. In one or more embodiments, once the partition is performed successfully, information related thereto can be generated and/or output by database management system 220 and stored in historic partitioning data repository 206 for future model training.

Also, as additionally depicted in FIG. 2, in one or more embodiments, cost model 227 can be used by partitioning analysis engine 212 to fine-tune one or more potential partition strategies by considering the cost of the given query (based at least in part on the explain and execute plan), the type of database, and/or at least one recommended threshold provided by a database administrator.

Accordingly, at least one embodiment includes building and/or maintaining historic partitioning data repository 206 to contain historical partition-related data and performance-related data associated with one or more databases (e.g., derived from database management system 220). Data engineering and data preprocessing can be carried out on at least a portion of the data stored in historic partitioning data repository 206 to understand and/or identify data features and data elements that can influence predictions and/or recommendations for database partitioning and related execution templates. Such preprocessing can include, for example, implementing multivariate-variate plots and correlation heatmaps to identify the significance of each of multiple features in given datasets such that un-important data elements can be filtered out. Such actions can reduce the dimensionality and complexity of the model used in connection with partitioning recommendation engine 214, hence improving the accuracy and performance of the model.

Also, in one or more embodiments, historic partitioning data repository 206 can contain database information including, for example, table names, attributes used for partitioning, table replication information, schema information, workload information, queries and related frequency information, partition type information, runtime for workload mixes, etc. In such an embodiment, sample data elements stored in historic partitioning data repository 206 and used for training at least one model in connection with partitioning recommendation engine 214 can include database object information and/or database table information (e.g., table name(s), number of attributes, etc.), volumetric trend information (e.g., the relevant record count and trend of data growth), workload information (e.g., input-output of database resources (e.g., storage, compute, etc.), frequently executed queries, etc.), query cost information and lineage details (e.g., explanation of plan(s) of commonly used queries), existing partitioning information (e.g., if partitioning exists, type of partitioning, usage pattern(s), allocated database resources, etc.), and data replication and archival strategy information (e.g., backup and recovery details).

As noted herein, tables can be scanned by a range predicate on a partitioning strategy, and a need exists to maintain a rolling window of data (as it can be difficult to complete periodic administrative operations, such as backup and restore, on certain tables (e.g., large tables) in an allotted time frame. Accordingly, one or more embodiments include enabling partial or full parallel partition-wise joins with approximately equisized partitions, resulting in improved query performance. To distribute data evenly among nodes of a given platform (e.g., a massively parallel processing (MPP) platform), partitioning will help minimize inter-connect traffic when processing internode parallel statements.

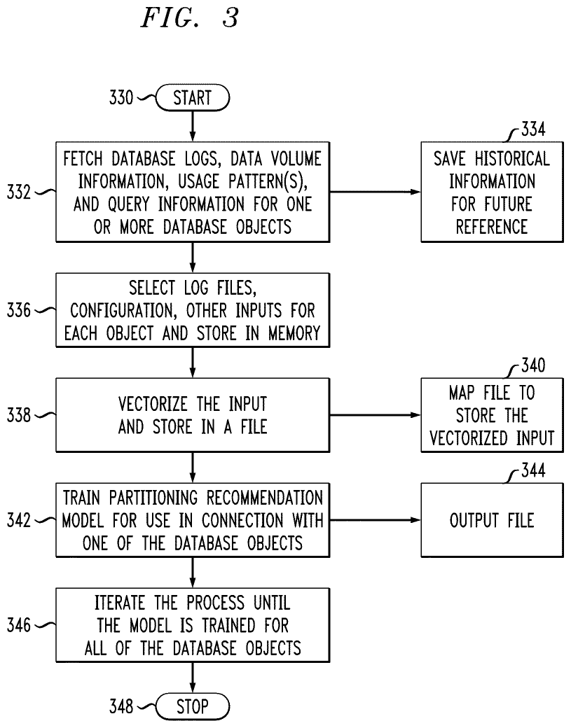

FIG. 3 shows an example workflow for training a partitioning recommendation model in an illustrative embodiment. The workflow starts at step 330, and step 332 includes fetching database logs, data volume information, usage pattern(s), and query information for one or more database objects (e.g., tables). Step 334 includes saving historical information, from the fetched information, for further reference and/or analysis. Step 336 includes selecting, from the fetched information, one or more log files, configuration information, and one or more other inputs for each of the one or more database objects, and storing such selected information in memory. Step 338 includes vectorizing the selected input information and storing the vectorized information in at least one file. Step 340 includes mapping the at least one file to store the vectorized information, wherein such mapping can include storing and/or maintaining historical information from the database(s) in at least one separate database which can be used for continuous model training and/or improved learning.

Step 342 includes training at least one partitioning recommendation model for use in connection with one of the one or more database objects, and step 344 includes outputting a file corresponding to the given database object. In one or more embodiments, the output file can include instructions specifying how to execute actions pertaining to the partition strategy based on the model output. Such instructions may take the form, for example, of a DML statement and/or query that creates the recommended partition. Further, step 346 includes iterating the training process (as described in step 342) until the at least one partitioning recommendation model is trained for all of the one or more database objects, and the workflow stops at step 348.

In at least one embodiment, at least one partitioning recommendation model (such as implemented, for example, by partitioning recommendation engine 114 and/or 214) leverages one or more deep reinforcement learning techniques to suggest and/or recommend partitioning strategies and/or actions. Such deep reinforcement learning techniques can include using at least one reward function to optimize future rewards, and in one or more embodiments, a deep reinforcement learning-based agent is implemented to determine recommendations based at least in part on experience by simulating and/or trying out different partitioning techniques and monitoring the rewards (e.g., the runtime benefits) for a variety of different workloads.

In such an embodiment, the deep reinforcement learning-based agent learns in multiple stages. An example first stage can include an offline phase wherein the deep reinforcement learning-based agent uses cost estimates to analyze trade-offs of using different partitioning techniques for different workloads. In another example phase, the deep reinforcement learning-based agent can be refined using real execution costs as rewards. Once trained, the deep reinforcement learning-based agent can be queried to obtain a partitioning strategy for a given database and/or to repartition a given deployed database (e.g., if the workload changes) to a new partitioning strategy that might be better suited for the current mix of queries.

In accordance with one or more embodiments, the deep reinforcement learning-based agent can not only determine and/or learn trade-offs associated with using different partitioning techniques for different workload mixes, but can also determine and/or learn trade-offs for different deployments. For example, consider a use case wherein a user can migrate a database to a new cluster by deploying a new set of virtual machines that have different hardware characteristics. Under the new hardware deployment, important factors such as the network bandwidth might change. Therefore, a new partitioning strategy and/or action (e.g., instead of replicating tables, partitioning tables might be more beneficial with increased network speed because network shuffling is cheaper and the benefits of partitioning due to a higher degree of parallelism outweigh the costs of data shuffling) is likely to be better suited for the new hardware deployment. Such trade-offs can be reflected in and/or learned by the deep reinforcement learning-based agent.

As such, in one or more embodiments, deep reinforcement learning is used in connection with training and implementing a partitioning advisor. As detailed above and herein, such an embodiment includes training a deep reinforcement learning-based agent to learn trade-offs in using different partitioning techniques for a given database schema. To facilitate the deep reinforcement learning-based agent to generalize to different workloads, different sample workload mixes (e.g., one or more sets of queries and their frequencies) are used for training the deep reinforcement learning-based agent. Once trained, the inference of the deep reinforcement learning-based agent can be used to derive at least one partitioning strategy (e.g., a recommended set of one or more partitioning techniques) that aims to reduce (e.g., to minimize) the overall runtime for a given workload mix.

In at least one embodiment, a deep reinforcement learning-based agent is trained using an offline training phase that uses cost estimates for a given workload as rewards for different partitioning techniques instead of actual query runtimes. This enables the deep reinforcement learning-based agent to learn trade-offs between different partitioning without executing the workload on a database (which, e.g., can be expensive and/or result in extensive training runtimes). Once the training is completed, the trained deep reinforcement learning-based agent can be used for inferencing partitioning techniques and/or recommendations.

Additionally, in one or more embodiments, the deep reinforcement learning-based agent can be further trained using a subsequent online training phase that further refines the deep reinforcement learning-based agent. For such an online training phase, at least one embodiment includes executing the given workload using different partitioning techniques and using actual runtimes as rewards for refining the decisions of the deep reinforcement learning-based agent. Such additional training helps the deep reinforcement learning-based agent to more effectively adopt the deep reinforcement learning-based agent to characteristics of a given deployment (e.g., different network speeds).

One or more embodiments can also include training multiple deep reinforcement learning-based agents and combining at least a portion of the multiple trained deep reinforcement learning-based agents to form a dynamic database partitioning committee. In such an embodiment, instead of training a single deep reinforcement learning-based agent which learns the trade-offs for all possible workload mixes, multiple agents can be trained and each such deep reinforcement learning-based agent can be trained to be the expert for a given subspace of workloads (e.g., a given mix of queries). Then, given a new workload mix, such an embodiment can include using the inference of the dedicated expert for the workload subspace to obtain a partitioning recommendation.

Also, at least one embodiment includes adapting one or more trained deep reinforcement learning-based agents via further incremental training if, for example, new queries are added to a workload or a given database schema changes. Additionally or alternatively, to support a completely new database schema and/or a workload for that schema, one or more embodiments include training a new set of deep reinforcement learning-based agents.

As detailed above, for example, in connection with FIG. 1 and FIG. 2, partitioning recommendation engine (element 114 and/or 214) leverages reinforcement learning techniques to recommend partitioning techniques and generate one or more execution templates related thereto. In one or more embodiments, the partitioning recommendation engine is trained with attributes and/or features of historical data containing performance events and database events for both target variables (i.e., recommended partitioning technique(s) and execution template(s)). Such attributes and/or features extracted from the historical data can include, for example, database descriptions, implemented partitioning techniques and attributes thereof, replication details, deployment details, queries, query frequencies, etc. In at least one embodiment, a deep reinforcement learning-based agent is trained on such a historical dataset, and in response to encountering one or more new situations and/or receiving one or more new prompts/requests, the trained deep reinforcement learning-based agent generates at least one recommendation pertaining to at least one partition type and at least one execution type.

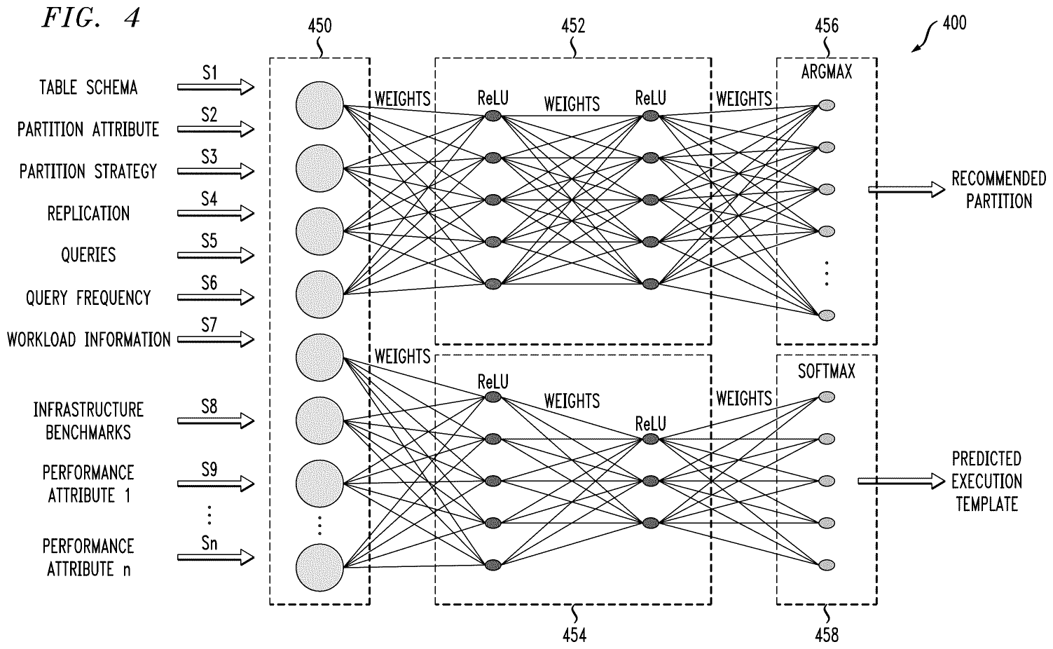

FIG. 4 shows an example deep learning neural network model used in an illustrative embodiment. By way of illustration, FIG. 4 depicts deep learning neural network model 400, which includes input layer 450, hidden layers 452 and 454, and output layers 456 and 458. In one or more embodiments, deep learning neural network model 400 can be included as part of and/or implemented by partitioning recommendation engine (e.g., element 114 and 214 in FIG. 1 and FIG. 2, respectively). Input layer 450 can include a number of neurons associated with a number of types of input data, such as, for example, table schema information (S1), partition attribute information (S2), partitioning strategy (S3), replication information (S4), queries (S5), query frequency (S6), workload information (S7), infrastructure benchmark (S8), performance attribute-1 (S9), . . . , performance attribute-n (Sn).

In connection with the FIG. 4, at least one embodiment includes utilizing deep learning neural network model 400 which can include a modified deep Q-network of Q masking, wherein inputs include new state information and outputs include estimated Q values of relevant actions. Accordingly, a modified deep Q-network has parallel branches of a network for different types of states, and by taking the state information (e.g., input variables) as a single input layer 450 and building a dense, multi-layer neural network, such a network can serve as a sophisticated learning component. Such a modified deep Q-network as depicted in FIG. 4 includes input layer 450, two hidden layers, 452 and 454, and two output layers, 456 and 458. As a multi-output neural network, the modified deep Q-network creates two separate branches of the network (in connection with hidden layers 452 and 454, as well as output layers 456 and 458) that connect to the same input layer 450.

Input layer 450, as noted above, includes a number of neurons that can match the number of input variables. Hidden layers 452 and 454 each include neurons which depend upon the number of neurons in input layer 450 (in connection with the use of one or more weights). The output layers 456 and 458 for each branch contain multiple neurons (in connection with the use of one or more weights) related to actions with Q values or execution template information. For example, in state/action branch (output layer 456), there can be nine neurons corresponding to nine states/actions. Additionally, while the neurons in hidden layers 452 and 454 use a rectified linear unit (ReLU) activation function, the neurons in output layer 456 utilize an argmax function for state/action recommendation(s) and the neurons in output layer 458 utilize a softmax function for execution template prediction(s).

It is to be appreciated that some embodiments described herein utilize one or more artificial intelligence models. It is to be appreciated that the term “model,” as used herein, is intended to be broadly construed and may comprise, for example, a set of executable instructions for generating computer-implemented recommendations. For example, one or more of the models described herein may be trained to generate recommendations based at least in part on event data and/or usage data collected from one or more databases, as well as historic partitioning data associated with one or more databases, and such recommendations can be used to initiate one or more automated actions (e.g., initiating one or more database partitioning operations, automatically training one or more artificial intelligence techniques, etc.).

FIG. 5 is a flow diagram of a process for dynamic database partitioning using artificial intelligence techniques in an illustrative embodiment. It is to be understood that this particular process is only an example, and additional or alternative processes can be carried out in other embodiments.

In this embodiment, the process includes steps 500 through 504. These steps are assumed to be performed by dynamic database partitioning system 105 utilizing elements 112, 114 and 116.

Step 500 includes identifying one or more performance issues associated with at least one database by processing activity data related to the at least one database. In at least one embodiment, processing activity data related to the at least one database (e.g., one or more of the managed databases 103 in the example FIG. 1 embodiment) includes processing data pertaining to at least one of one or more database log files, one or more query execution patterns, query cost information, and one or more database health parameters.

Step 502 includes determining one or more partitioning actions to be carried out in connection with the at least one database by processing at least a portion of the activity data related to the one or more identified performance issues using one or more artificial intelligence techniques. In one or more embodiments, determining one or more partitioning actions includes processing the at least a portion of the activity data using one or more deep reinforcement learning techniques. In such an embodiment, determining one or more partitioning actions includes simulating, using at least a portion of the one or more deep reinforcement learning techniques, one or more partitioning actions in connection with one or more different workloads.

Additionally or alternatively, determining one or more partitioning actions can include recommending, to at least one of at least one user associated with the at least one database and at least one system associated with the at least one database, the one or more partitioning actions and outputting at least one execution template corresponding to at least a portion of the one or more recommended partitioning actions.

In one or more embodiments, determining one or more partitioning actions includes processing the at least a portion of the activity data using at least one deep learning neural network model. In such an embodiment, processing the at least a portion of the activity data using at least one deep learning neural network model can include implementing a first one of multiple branches of the at least one deep learning neural network model trained to recommend the one or more partitioning actions and implementing a second one of the multiple branches of the at least one deep learning neural network model trained to determine at least one execution template corresponding to at least a portion of the one or more recommended partitioning actions.

Step 504 includes performing one or more automated actions based at least in part on the one or more determined partitioning actions. In at least one embodiment, performing one or more automated actions includes automatically initiating at least a portion of the one or more determined partitioning actions in connection with the at least one database. Additionally or alternatively, performing one or more automated actions can include automatically training at least a portion of the one or more artificial intelligence techniques based at least in part on feedback related to the one or more determined partitioning actions.

The techniques depicted in FIG. 5 can also include training at least a portion of the one or more artificial intelligence techniques using one or more of table name information, data pertaining to one or more attributes used for partitioning, table replication information, schema information, workload information, query information, query frequency information, partition action type information, and runtime information for one or more workloads.

Accordingly, the particular processing operations and other functionality described in conjunction with the flow diagram of FIG. 5 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to generate and/or implement dynamic database partitioning recommendations using artificial intelligence techniques. These and other embodiments can effectively overcome problems associated with costly over-allocation of storage space and/or related system downtime.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

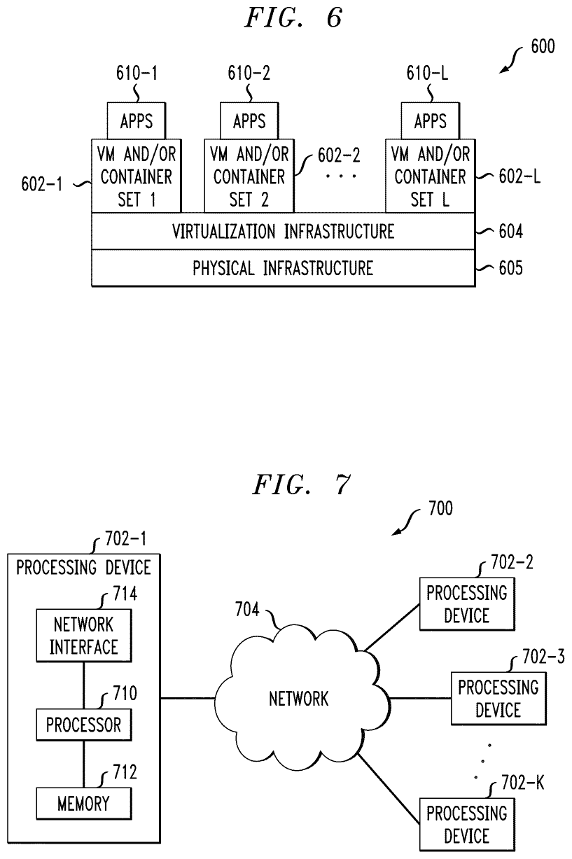

Illustrative embodiments of processing platforms will now be described in greater detail with reference to FIGS. 6 and 7. Although described in the context of system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, wherein the hypervisor platform has an associated virtual infrastructure management system. The underlying physical machines comprise one or more information processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a CPU, a GPU, a TPU, a microcontroller, an ASIC, a FPGA or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
identifying one or more performance issues associated with at least one database by processing activity data related to the at least one database;
determining one or more partitioning actions to be carried out in connection with the at least one database by processing at least a portion of the activity data related to the one or more identified performance issues using one or more artificial intelligence techniques; and
performing one or more automated actions based at least in part on the one or more determined partitioning actions;
wherein the method is performed by at least one processing device comprising a processor coupled to a memory.

2. The computer-implemented method of claim 1, wherein determining one or more partitioning actions comprises processing the at least a portion of the activity data using one or more deep reinforcement learning techniques.

3. The computer-implemented method of claim 2, wherein determining one or more partitioning actions comprises simulating, using at least a portion of the one or more deep reinforcement learning techniques, one or more partitioning actions in connection with one or more different workloads.

4. The computer-implemented method of claim 1, wherein determining one or more partitioning actions comprises recommending, to at least one of at least one user associated with the at least one database and at least one system associated with the at least one database, the one or more partitioning actions and outputting at least one execution template corresponding to at least a portion of the one or more recommended partitioning actions.

5. The computer-implemented method of claim 1, wherein performing one or more automated actions comprises automatically initiating at least a portion of the one or more determined partitioning actions in connection with the at least one database.

6. The computer-implemented method of claim 1, wherein performing one or more automated actions comprises automatically training at least a portion of the one or more artificial intelligence techniques based at least in part on feedback related to the one or more determined partitioning actions.

7. The computer-implemented method of claim 1, wherein determining one or more partitioning actions comprises processing the at least a portion of the activity data using at least one deep learning neural network model.

8. The computer-implemented method of claim 7, wherein processing the at least a portion of the activity data using at least one deep learning neural network model comprises implementing a first one of multiple branches of the at least one deep learning neural network model trained to recommend the one or more partitioning actions and implementing a second one of the multiple branches of the at least one deep learning neural network model trained to determine at least one execution template corresponding to at least a portion of the one or more recommended partitioning actions.

9. The computer-implemented method of claim 1, wherein processing activity data related to the at least one database comprises processing data pertaining to at least one of one or more database log files, one or more query execution patterns, query cost information, and one or more database health parameters.

10. The computer-implemented method of claim 1, further comprising:
training at least a portion of the one or more artificial intelligence techniques using one or more of table name information, data pertaining to one or more attributes used for partitioning, table replication information, schema information, workload information, query information, query frequency information, partition action type information, and runtime information for one or more workloads.

11. A non-transitory processor-readable storage medium having stored therein program code of one or more software programs, wherein the program code when executed by at least one processing device causes the at least one processing device:
to identify one or more performance issues associated with at least one database by processing activity data related to the at least one database;
to determine one or more partitioning actions to be carried out in connection with the at least one database by processing at least a portion of the activity data related to the one or more identified performance issues using one or more artificial intelligence techniques; and
to perform one or more automated actions based at least in part on the one or more determined partitioning actions.

12. The non-transitory processor-readable storage medium of claim 11, wherein determining one or more partitioning actions comprises processing the at least a portion of the activity data using one or more deep reinforcement learning techniques.

13. The non-transitory processor-readable storage medium of claim 11, wherein determining one or more partitioning actions comprises recommending, to at least one of at least one user associated with the at least one database and at least one system associated with the at least one database, the one or more partitioning actions and outputting at least one execution template corresponding to at least a portion of the one or more recommended partitioning actions.

14. The non-transitory processor-readable storage medium of claim 11, wherein performing one or more automated actions comprises automatically initiating at least a portion of the one or more determined partitioning actions in connection with the at least one database.

15. The non-transitory processor-readable storage medium of claim 11, wherein performing one or more automated actions comprises automatically training at least a portion of the one or more artificial intelligence techniques based at least in part on feedback related to the one or more determined partitioning actions.

16. An apparatus comprising:
at least one processing device comprising a processor coupled to a memory;
the at least one processing device being configured:
to identify one or more performance issues associated with at least one database by processing activity data related to the at least one database;
to determine one or more partitioning actions to be carried out in connection with the at least one database by processing at least a portion of the activity data related to the one or more identified performance issues using one or more artificial intelligence techniques; and
to perform one or more automated actions based at least in part on the one or more determined partitioning actions.

17. The apparatus of claim 16, wherein determining one or more partitioning actions comprises processing the at least a portion of the activity data using one or more deep reinforcement learning techniques.

18. The apparatus of claim 16, wherein determining one or more partitioning actions comprises recommending, to at least one of at least one user associated with the at least one database and at least one system associated with the at least one database, the one or more partitioning actions and outputting at least one execution template corresponding to at least a portion of the one or more recommended partitioning actions.

19. The apparatus of claim 16, wherein performing one or more automated actions comprises automatically initiating at least a portion of the one or more determined partitioning actions in connection with the at least one database.

20. The apparatus of claim 16, wherein performing one or more automated actions comprises automatically training at least a portion of the one or more artificial intelligence techniques based at least in part on feedback related to the one or more determined partitioning actions.
